(19) United States
(12) Patent Application Publication
(10) Pub. No.: US 2004/0258456 A1
(43) Pub. Date: Dec. 23, 2004

(54) Uncial pen

(76) Inventor: William Taylor, Petersburg, VA (US)

Correspondence Address: William Taylor # 23219-016, FCI-Medium, P.O. Box 90043, Petersburg, VA, 23804, US

(21) Appl. No.: 10/836,452

(22) Filed: Aug. 3, 2004

Related U.S. Application Data
(60) Provisional application No. 60/480,400, filed on Jun. 23, 2003.

(51) Int. Cl. B43K 5/16; B43K 24/02

(52) U.S. Cl. 401/195

(57) ABSTRACT

The nature of the technical disclosure of the Uncial Pen is very common sense, there is a liquid crystal screen display on the right side of the pen to show the Month, Day, and Year, and on the left side is the Time shown by a liquid crystal screen display, which operaters by a 1.5 volt watch size battery that's inserted in the top of the cap of the pen.

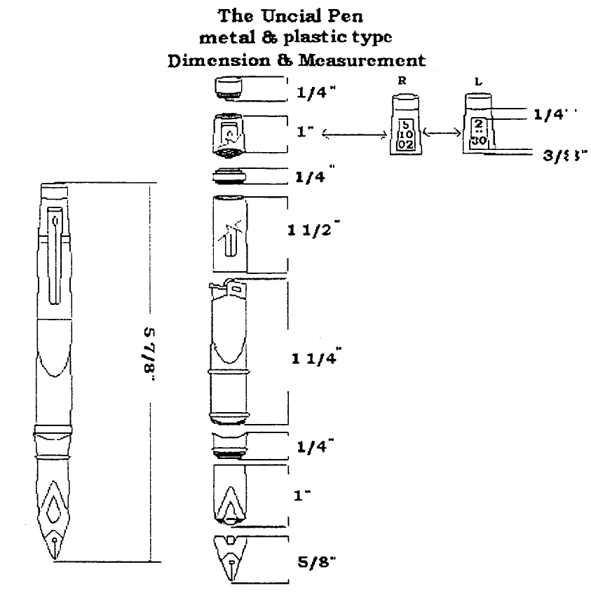

The cap which contains these features can be removed to display a Butane Cigarette Lighter. Then at the very bottom of the Uncial Pen is the Ink Pen writing part, this part moves in and out by the twist of the pen's cap when used for writing or not writing. And finally it screws apart in the middle where it can be refilled with ink and butane fluid, No pen has ever been created in the art world like this.

### DESCRIPTIVE TITLE OF THE INVENTION

This is a very unique and original pen, for it has several features unlike any other pen that has been created.

This pen features, the month, date, and year on the right upper part of the pen, and directly opposite on the left side is a clock.

The battery goes in the very top of the pen which screws off so it can be placed inside.

Also, once the top half of the pen is removed a butane lighter is available and ready for use. And last but not least, the ink pen writing part on the bottom half of the pen.

### BACKGROUND OF THE INVENTION

The UNCIAL PEN was the direct result of experimentation with things already invented, but looking at it from one's mind from the point of view of what I as an inventor can do to this pen to make it different from every other pen ever created.

I looked at various styles of pens, the shapes, sizes, width and just used an inventive mind to add, take away, mold and shape images into my mind to create the UNCIAL PEN.

1. I do hereby claim as my invention the UNCIAL PEN, this pen which features are a liquid crystal screen display on the right side to show the day, month, and year, also on the left is a liquid crystal screen display to show the time. The Uncial Pen also has a butane lighter as another feature, the lighter is concealed by the cap which holds the battery and contains both screens, however the cap is removable. Then finally there is the ink pen writing part at the very bottom. All these features together combine into a single instrument to create the UNCIAL PEN, I claim as my invention.
